(19) United States
(12) Patent Application Publication
(10) Pub. No.: US 2004/0251434 A1
(43) Pub. Date: Dec. 16, 2004

(54) ERGONOMIC APPARATUS FOR CUTTING SPECIMENS

(75) Inventors: Michael Zimmermann, Leopoldsdorf (AT); Reinhard Lihl, Vienna (AT); Andreas Hallady, Vienna (AT); Anton Lang, Vienna (AT)

Correspondence Address: SIMPSON & SIMPSON, PLLC, 5555 MAIN STREET, WILLIAMSVILLE, NY, 14221-5406, US

(73) Assignee: Leica Mikrosysteme GmbH, Vienna (AT)

(21) Appl. No.: 10/709,874

(22) Filed: Jun. 2, 2004

(30) Foreign Application Priority Data
Jun. 7, 2003 (DE) 103 25 945.7

(51) Int. Cl. G06M 7/00

(52) U.S. Cl. 250/559.12

(57) ABSTRACT

In cutting devices (10), in particular microtomes or ultramicrotomes, it is necessary to preset the specimen (14) onto the knife (16). To simplify this presetting operation, which is intended to ensure the quickest and most accurate possible positioning of the knife (16) relative to the specimen (14), a stereomicroscope (12) is provided that can be adjusted in many ways using operating elements (15, 17, 19, 27). To improve the unit's ergonomics and additionally eliminate collisions during pivoting, the unit base (22) of the cutting device (10) is modified. Since the modification of the unit base must result in a lowering, this modification can be achieved by lowering the knife holder (26), the mounting surface for the linear guide being milled directly onto the unit base (22).

### CROSS REFERENCE TO RELATED APPLICATIONS

This application claims priority of the German patent application 103 25 945.7, filed Jun. 7, 2003, which is incorporated by reference herein.

### FIELD OF THE INVENTION

The invention concerns a cutting apparatus for cutting specimens.

### BACKGROUND OF THE INVENTION

When a cutting apparatus, in particular a microtome or an ultramicrotome, is operated, it is routinely necessary for the preparation being cut to be positioned quickly, exactly, and in accurately positioned fashion with respect to the knife. During operation a number of operating actions must furthermore be performed, in which actuation or alignment devices of the microscope are utilized by the user. It is often necessary in this context to actuate the operating elements “blind,” without losing sight of the specimen that in the meantime is being viewed with a stereomicroscope. Operation must therefore be accomplished, in many cases, without visual contact with the operating element.

A cutting apparatus of this kind having a stereomicroscope is disclosed, for example, by DE 40 12 600. In the context of the presetting operation between knife and specimen, the approach operation between the specimen and knife is assisted using an observation device, specifically a stereomicroscope. With the use of the stereomicroscope, it is also possible to assist the operation of precisely observing and performing the various angular adjustments that are required. The alignment can be observed by a user himself; alternatively, a camera can also be mounted on the stereomicroscope.

In known cutting devices, for example the Reichert Ultra-cut S of the Leica company, a stereomicroscope having a variably adjustable magnification is used. The stereomicroscope itself is installed with a fixed angle of 20° between the optical axis of the stereomicroscope and its vertical. This has the advantage that an accurate alignment of knife and specimen can be performed for many instances, especially if the relief angle of the knife is 10°. This is because the base-mounted illumination system that is used for alignment has a light exit vertically beneath the knife edge. The light is reflected from the knife edge, at twice the relief angle (i.e. 20°), to the specimen and from there to the stereomicroscope. Under these geometrical conditions, the spacing between the knife and specimen is detectable in the stereomicroscope as a bright gap. The incident-light illumination system that serves for observation of the sections is adapted geometrically in such a way that with this angular arrangement of the stereomicroscope, the water surface acts reflectively. With this microtome, the stereomicroscope can be rotated about the angle setting axis; a linear motion of the stereomicroscope and a focus adjustment can be controlled via operating elements. The fixed arrangement of the stereomicroscope at a defined angle ensures that the aforementioned motions do not cause a collision.

On the other hand, however, depending on the specimen that is to be cut, it is often necessary to lower the water level in the knife. The lowered water surface is curved, however, so that the reflectivity of the water surface close to the knife edge is lost. To allow an optimum setting of the stereomicroscope to be made under as many different conditions as possible, a pivotable stereomicroscope has therefore already been used in several units. Ultramicrotomes of the RMC company, for example, in this case e.g. the MTX or MTCL models, possess this pivoting capability. The pivot axis does not, however, coincide with the direction of the knife edge, but instead extends along the underside of the focus drive. The result of this configuration, however, is that a number of collision possibilities exist in the context of the various adjustment operations. For example, the specimen arm can cause a collision with the vertically adjustable illumination system while being moved up and down. In addition, the stereomicroscope and the illumination system can collide with the housing, in particular with the ultramicrotome hood, when the microscope carrier is rotated 90 degrees.

Because of the need for stability, known cutting units have a heavy base on which the knife holder and specimen arm mount are constructed. The result, however, is that the unit base is very thick, and that thickness increases toward the rear, i.e. from the stereomicroscope toward the specimen holder. The thickness of the base in turn means that the operating elements must be arranged at a height that is not ergonomic—in particular, is too high—for the user. Rapid fatigue is the consequence. Attempts to counteract this by attaching an additional handrest have had only limited success, since contact with the unit during cutting must be avoided. Handrests are also obstructive when aligning the knife and preparation. This in turn means that additional effort must be expended to make the handrests foldable or easily removable.

### SUMMARY OF THE INVENTION

It is therefore the object of the present invention to propose apparatus for cutting specimens, in particular a microtome or an ultramicrotome, in which the possibility of collisions during adjustment operations is largely eliminated and the operating elements are ergonomically arranged.

This object is achieved, according to the present invention, by a cutting apparatus for cutting specimens comprising: an observation device, in particular a stereomicroscope with an objective, a unit base, a knife carrier, an X-Y stage on which the knife carrier is mounted, a linear guide for displacement of the X-Y stage and a plurality of mounting surfaces for the linear guide are milled, directly on the unit base.

It is a further object of the present invention to provide a microtome or an ultramicrotome, for cutting specimens comprising: a stereomicroscope with an objective, wherein the objective has an increased working distance, of 110 mm, an illumination device is arranged in such a way that it also pivots as the stereomicroscope pivots, a unit base, a knife carrier, an X-Y stage on which the knife carrier is mounted, a linear guide for displacement of the X-Y stage, and a plurality of mounting surfaces for the linear guide are milled, directly on the unit base.

The basic idea of the present invention is thus to modify the unit base of the cutting device in such a way that the height of the operating elements is considerably lowered. Since the purpose of modifying the unit base is to achieve lowering, this modification can be achieved, or can be accompanied, by a lowering of the knife holder. The previously required mounting plate for the linear drive system is dispensed with, and the mounting surface for the linear guide is milled directly onto the unit base.

The requisite stability of the unit can be achieved with the use of stiffening ribs. These are preferably applied vertically upward, i.e. they are directed upward from the plane of the unit base so that a lower configuration can be achieved.

In a preferred embodiment of the invention, the working distance of the objective is increased so that the working distance of the stereomicroscope can be maintained.

Advantageously, there is provided on the stereomicroscope a pivoting device that is coupled to an illumination device for illuminating the specimen. This ensures that the illumination device also pivots as the stereomicroscope pivots, and the illumination point is thus maintained.

It is furthermore advantageous to provide the operating knobs of the cutting device in stepped fashion, i.e. to mount the operating knobs on the cutting device in such a way that the profile of their lateral extension is stepped. As a result, it is possible to identify the respective operating knob solely on the basis of its lateral position, simplifying operation without visual contact with the operating knob.

In a further embodiment of the invention, the unit hood of the cutting device is configured in such a way that upon pivoting of the stereomicroscope about its pivot axis, the illumination device and the stereomicroscope can be moved past the unit hood without contact between them, so that collisions can be avoided.

### BRIEF DESCRIPTION OF THE DRAWINGS

Further advantages and advantageous embodiments of the invention are the subject matter of the Figures below and their descriptions.

In the individual Figures:

FIG. 1 is a side view of an apparatus according to the existing art for cutting specimens;

FIG. 2 is a plan view of an apparatus according to the existing art for cutting specimens;

FIG. 3 is a side view of an apparatus according to the present invention for cutting specimens;

FIG. 4 is a front view of an apparatus according to the present invention for cutting specimens;

FIG. 5 is a plan view of an apparatus according to the present invention for cutting specimens.

### DETAILED DESCRIPTION OF THE INVENTION

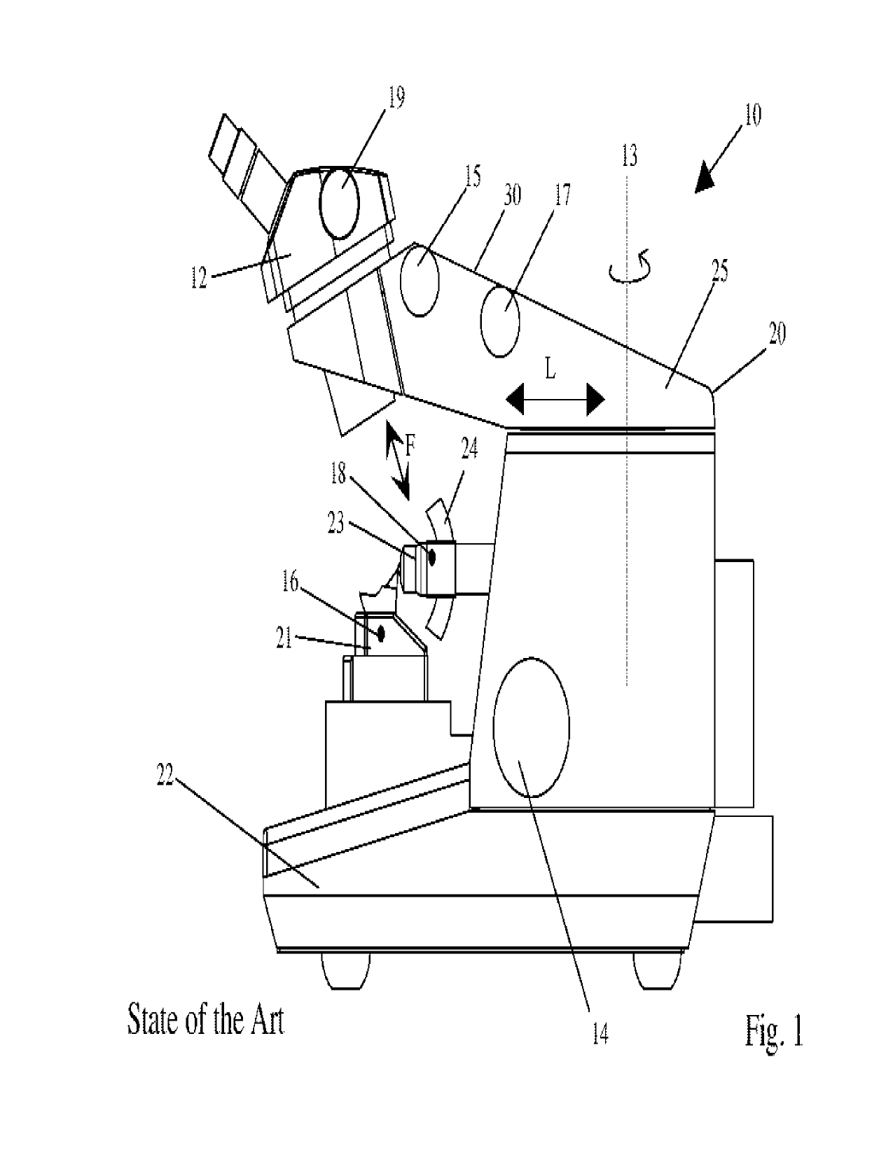

FIG. 1 is a side view of a cutting device according to the existing art, cutting apparatus 10 being embodied here as an ultramicrotome. It has a stereomicroscope 12 that has operating elements 19 for magnification adjustment, 15 for focus travel F, and 17 for a linear motion L. An alignment device 16 is provided on knife carrier 21. A specimen alignment device 18 is provided on specimen holder 23, which is connected to segmental curved member 24. To improve access to specimen holder 23 and to the knife, stereomicroscope carrier 30 is rotatable about axis 13. Stereomicroscope carrier 30 is covered by a covering hood 25. The components of the ultramicrotome are mounted on a relatively thick base 22 whose thickness increases toward the rear, i.e. from the stereomicroscope toward specimen holder 23.

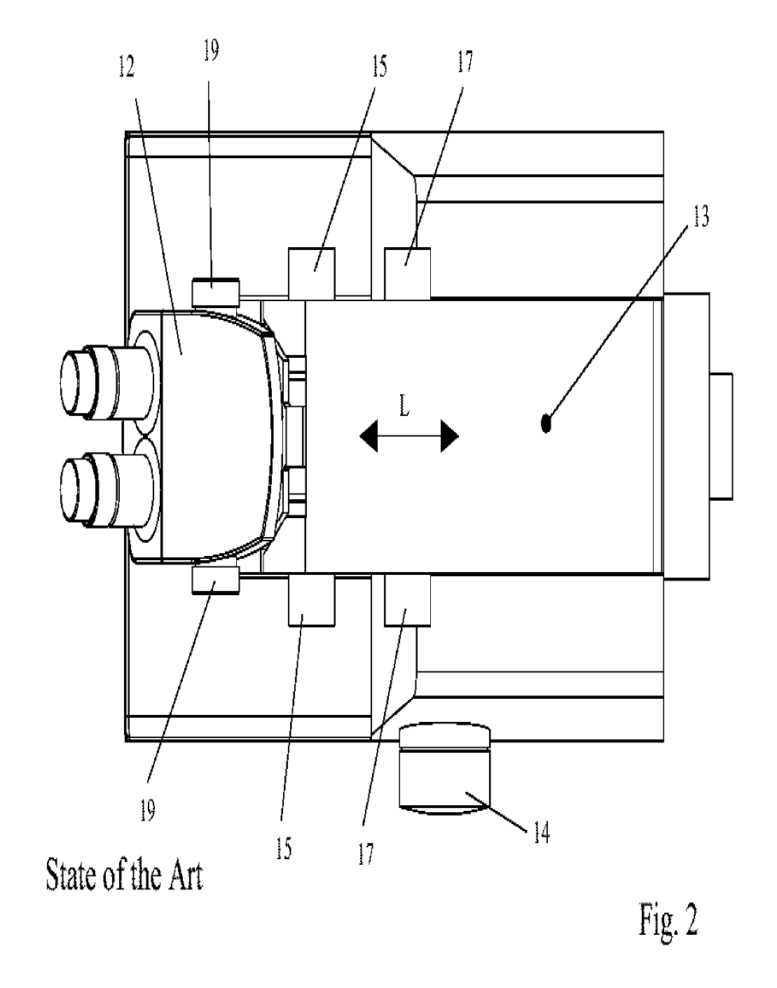

As is evident from FIG. 2, operating elements 15 and 17 are provided on either side of stereomicroscope 12. Displacement L can be effected in the direction of the double arrow. Also shown are rotation axis 13 and handwheel 14. Operating elements 15 and 17, in particular, have substantially the same dimension perpendicular to displacement direction L.

Units of this kind as known from the existing art have a number of disadvantages. Pivoting of the microscope carrier can result in collisions with the housing. This must, however, be avoided at all costs when producing thin sections. As is evident from FIGS. 1 and 2, the essential operating elements are arranged in ergonomically unfavorable positions. Since they are placed too high for the user, rapid user fatigue is often the consequence. These operating elements are substantially handwheel 14, the alignment devices on knife carrier 16, and the alignment device on the segmental curved member having specimen holder 18. The operating elements for positioning and focusing stereomicroscope 12, i.e. operating elements 15, 17, and 19, are likewise arranged in ergonomically unfavorable fashion.

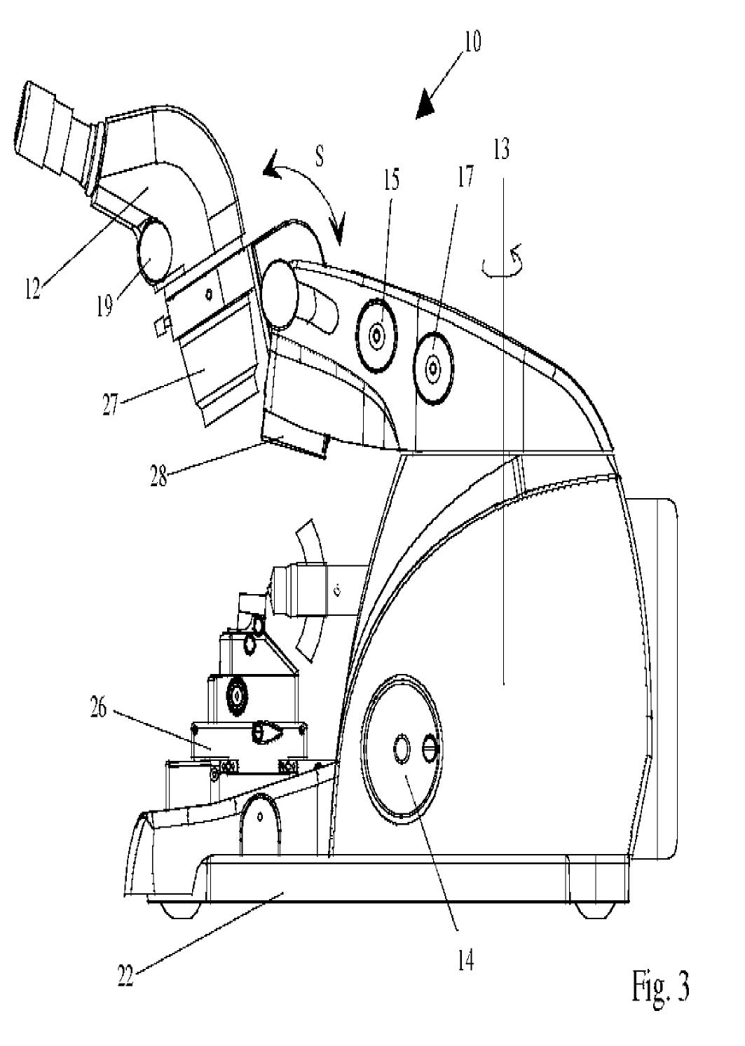

FIGS. 3 through 5 depict, in various views, the cutting device improved according to the present invention. It is clearly evident from the side view of FIG. 3 that unit base 22 has been modified, i.e. flattened. This modification was achieved by decreasing the height of X-Y stage 26 on which the knife holder is retained. For this purpose, mounting surfaces for the linear guide were milled directly onto unit base 22. An additional mounting plate on unit base 22 can thus be dispensed with. It is additionally possible to provide reinforcing ribs, which preferably project upward and thus ensure the requisite stability. At the same time, this permits a lower overall height.

Despite this modified physical configuration, the viewing position of stereomicroscope 12 can be maintained. This is done by increasing the working distance of objective 27. In a preferred embodiment, this can be achieved by selecting a working distance of 110 mm instead of a working distance of 90 mm. The direct result of this is that more space is available for any manipulations that need to be performed in the knife/specimen region.

To allow stereomicroscope 12 to be adapted to the requirements of different specimens, a pivoting capability in pivoting direction S is usually provided. To ensure that good illumination continues to be provided as pivoting occurs about the knife edge, incident-light illumination system 28 is designed so that it is also moved a certain distance in direction S as the stereomicroscope pivots. This eliminates the additional pivoting of illumination device 28 that would otherwise be necessary.

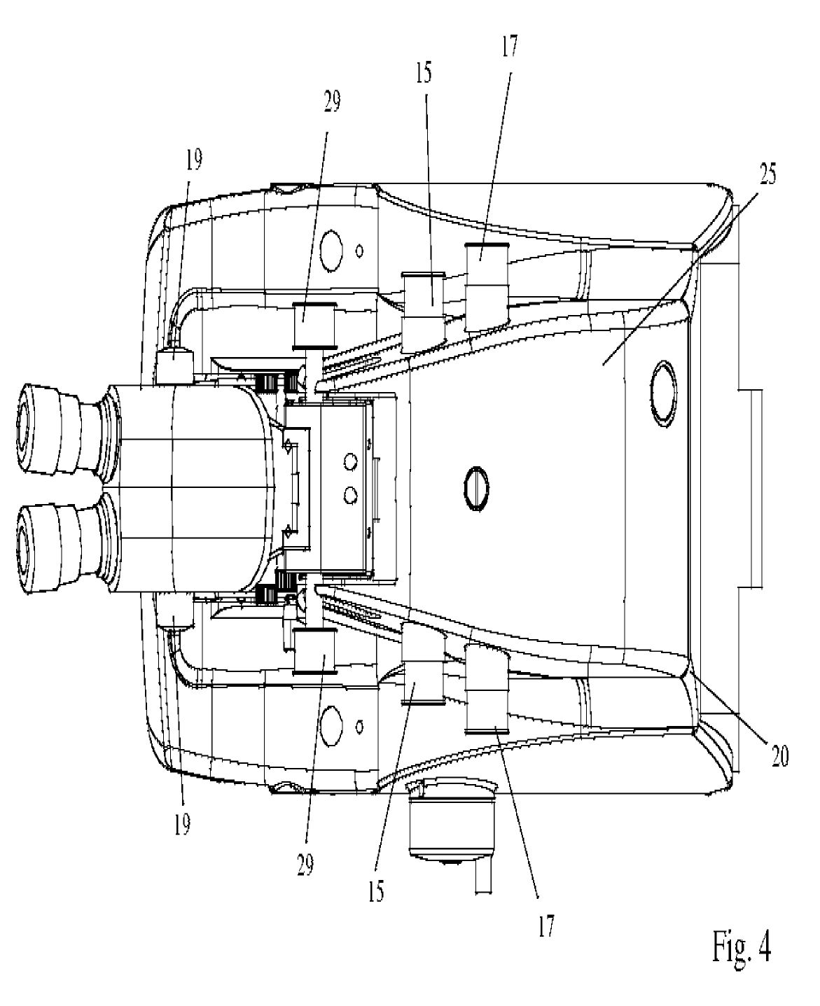

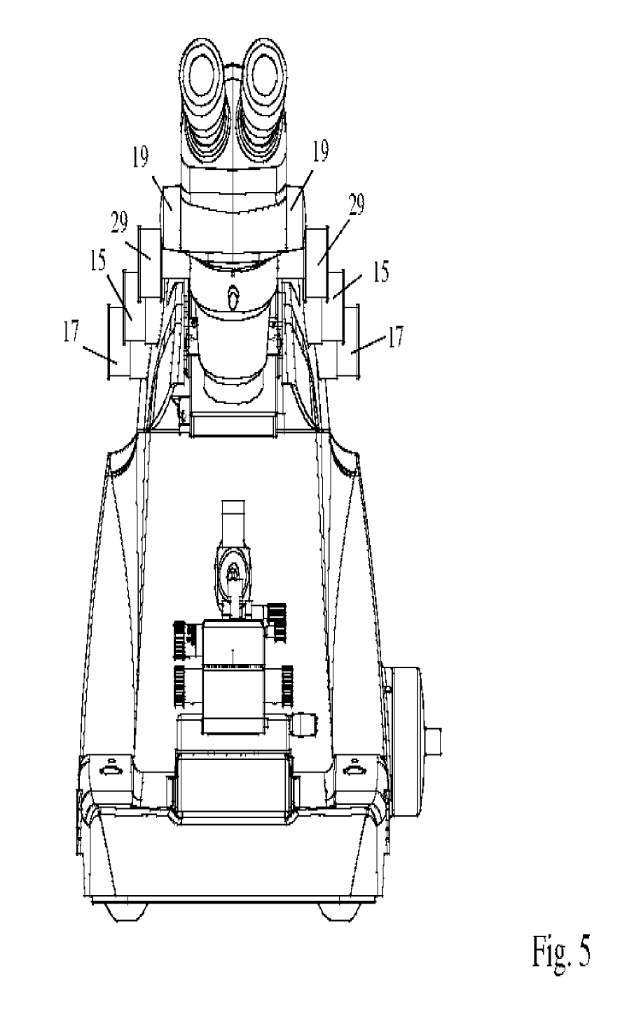

As shown in the plan view of FIG. 4 and the front view of FIG. 5, operating elements 19, 29, 15, and 17 are arranged in stepped fashion in terms of their length, i.e. their lateral location, to allow for easy operation even without visual contact with the operating elements. By simply touching the operating elements, it is possible to ascertain which one is presently being grasped. It is thus easy to perform specific manipulations of the position of the stereomicroscope or its focus. The stepped arrangement of the operating elements moreover makes a contribution to improved ergonomics, since operating elements located close together can now be actuated better and more easily. It is almost impossible for the user's fingers to become caught.

A covering hood 25 of the microtome has corners 20 whose shape is adapted in such a way that potential collisions with stereomicroscope 12 or with illumination system 28 are avoided. Corners 20 were therefore largely removed. This was done by recessing covering hood 25 at corner points 20 So that even when stereomicroscope carrier 30 is pivoted about axis 13, a collision of illumination system 28 cannot occur in any pivot position 9 of stereomicroscope 12. Each corner 20 to the left and the right on covering hood 25 is embodied as a bevel. The bevel prevents collisions with illumination system 28 upon pivoting about axis 13.

1. A cutting apparatus, in particular a microtome or an ultramicrotome, for cutting specimens, comprising an observation device, in particular a stereomicroscope with an objective, a unit base, a knife carrier, an X-Y stage on which the knife carrier is mounted, a linear guide for displacement of the X-Y stage and a plurality of mounting surfaces for the linear guide are milled, directly on the unit base.

2. The cutting apparatus as defined in claim 1, wherein stiffening ribs, which are directed upward from a plane of the unit base, are provided in order to enhance stability.

3. The cutting apparatus as defined in claim 1, wherein the objective has an increased working distance, in particular of 110 mm.

4. The cutting apparatus as defined in claim 1, wherein the observation device comprises a pivoting device on which an illumination device is arranged in such a way that it also pivots as the observation device pivots.

5. The cutting apparatus as defined in claim 1, wherein a plurality of operating knobs are provided that are arranged in stepped fashion with respect to one another in terms of their lateral position on the stereomicroscope.

6. The cutting apparatus as defined in claim 1, wherein a unit hood is provided whose corners are recessed in such a way that upon pivoting of the stereomicroscope about its pivot axis, the illumination device and the stereomicroscope can be moved past the unit hood with no contact between them.

7. A microtome or an ultramicrotome, for cutting specimens, comprising a stereomicroscope with an objective, wherein the objective has an increased working distance, of 110 mm, a unit base, a knife carrier, an X-Y stage on which the knife carrier is mounted, a linear guide for displacement of the X-Y stage, and a plurality of mounting surfaces for the linear guide are milled, directly on the unit base.

8. A microtome or an ultramicrotome, for cutting specimens, comprising: a stereomicroscope with an objective, wherein the objective has an increased working distance, of 110 mm, an illumination device is arranged in such a way that it also pivots as the stereomicroscope pivots, a unit base, a knife carrier, an X-Y stage on which the knife carrier is mounted, a linear guide for displacement of the X-Y stage, and a plurality of mounting surfaces for the linear guide are milled, directly on the unit base.

9. A microtome or an ultramicrotome, for cutting specimens, comprising a stereomicroscope with an objective, wherein the objective has an increased working distance, of 110 mm, a plurality of operating knobs that are arranged in stepped fashion with respect to one another in terms of their lateral position on the stereomicroscope, a unit base, a knife carrier, an X-Y stage on which the knife carrier is mounted, a linear guide for displacement of the X-Y stage, and a plurality of mounting surfaces for the linear guide are milled, directly on the unit base.

10. A microtome or an ultramicrotome, for cutting specimens, comprising a stereomicroscope with an objective, wherein the objective has an increased working distance, of 110 mm, an illumination device is arranged in such a way that it also pivots as the stereomicroscope pivots, a unit hood whose corners are recessed in such a way that upon pivoting of the stereomicroscope about its pivot axis, the illumination device and the stereomicroscope can be moved past the unit hood with no contact between them, a unit base, a knife carrier, an X-Y stage on which the knife carrier is mounted, a linear guide for displacement of the X-Y stage, and a plurality of mounting surfaces for the linear guide are milled, directly on the unit base.
